(19) United States
(12) Patent Application Publication
(10) Pub. No.: US 2012/0169699 A1
(43) Pub. Date: Jul. 5, 2012

(54) ORGANIC LUMINESCENT DISPLAY DEVICE AND METHOD OF MANUFACTURING THE SAME

(75) Inventor: Hyun-Eok Shin, Yongin-city (KR)

(73) Assignee: Samsung Mobile Display Co., Ltd., Yongin-city (KR)

(21) Appl. No.: 13/338,973

(22) Filed: Dec. 28, 2011

(30) Foreign Application Priority Data
Jan. 4, 2011 (KR) 10-2011-0000586

(51) Int. Cl. G09G 3/30; H01J 9/00

(52) U.S. Cl. 345/211; 445/24; 345/76

(57) ABSTRACT

An organic luminescent display device and a method of manufacturing the same are disclosed. The organic luminescent display device includes a scan line and a data line which intersect each other at different levels and an interlayer insulating film which insulates the scan line from the data line. The display device also includes a residual data line which is insulated and formed separately from the data line, extends parallel to the scan line, and is connected to the scan line by a plurality of contact holes and/or a residual scan line which is insulated and formed separately from the scan line, extends parallel to the data line, and is connected to the data line by a plurality of contact holes.

### CROSS-REFERENCE TO RELATED APPLICATION

This application claims priority from Korean Patent Application No. 10-2011-0000586 filed on Jan. 4, 2011 in the Korean Intellectual Property Office, the disclosure of which is incorporated herein by reference in its entirety.

### BACKGROUND

1. Field

The disclosed technology relates to an organic luminescent display device, and more particularly, to an organic luminescent display device having a low resistance wiring structure.

2. Description of the Related Technology

As the demand for portable display devices such as mobile phones, notebooks, and personal digital assistants (PDAs) increases, the development of flat panel displays (FPDs) is desired. In particular, organic luminescent display devices using organic light-emitting diodes (OLEDs) are being actively developed. An OLED is a self-luminous element that emits light. Since OLEDs do not require a backlight that is essential in liquid crystal displays (LCDs), they are suitable for making display devices thinner. Furthermore, organic luminescent display devices using OLEDs exhibit wide viewing angle characteristics and high response speed characteristics.

As display panels become larger in size and are required to provide higher definition, the amount of current and data that are transferred per unit of time increases. Therefore, the resistance of the wiring needs to be reduced. In particular, wiring resistance causes a resistive-capacitive (RC) delay. Therefore, various structures are being suggested to reduce wiring resistance in order to reduce the RC delay of an organic luminescent display device.

### SUMMARY OF CERTAIN INVENTIVE ASPECTS

One inventive aspect is an organic luminescent display device including a scan line and a data line which intersect each other at different levels and an interlayer insulating film which insulates the scan line from the data line. The display device also includes a residual data line which is insulated and formed spaced apart from the data line, where the residual data line is parallel to the scan line and is connected to the scan line by a plurality of contact holes, a plurality of pixels formed in a region defined by the scan line and the data line, and one or more thin-film transistors which selectively apply voltages to the pixels.

Another inventive aspect is an organic luminescent display device including a scan line and a data line which intersect each other at different levels and an interlayer insulating film which insulates the scan line from the data line. The display device also includes a residual scan line which is insulated and formed spaced apart from the scan line, where the residual data line is parallel to the data line and is connected to the data line by a plurality of contact holes, a plurality of pixels formed in a region defined by the scan line and the data line, and one or more thin-film transistors which selectively apply voltages to the pixels.

Another inventive aspect is a method of manufacturing an organic luminescent display device, the method including providing a scan line material on a substrate, forming a scan line by patterning the scan line material, forming an interlayer insulating film on the scan line, and forming a plurality of contact holes in the interlayer insulating film. The method also includes providing a data line material on the substrate, forming a data line which extends in a first direction by patterning the data line material, and forming a residual data line which extends in a direction different from the first direction and is insulated from the data line by patterning the remainder of the data line material, where the residual data line and the scan line are connected to each other by the contact holes.

Another inventive aspect is a method of manufacturing an organic luminescent display device, the method including providing a scan line material on a substrate, forming a scan line which extends in a first direction by patterning the scan line material, and forming a residual scan line which extends in a direction different from the first direction and is insulated from the scan line by patterning the remainder of the scan line material. The method also includes forming an interlayer insulating film on the scan line, forming a plurality of contact holes at locations, which correspond to the residual scan line, in the interlayer insulating film, providing a data line material on the substrate, and forming a data line by patterning the data line material.

### BRIEF DESCRIPTION OF THE DRAWINGS

FIG. 1 is a plan view of organic luminescent display devices according to certain exemplary embodiments;

FIG. 2 is an equivalent circuit diagram of one pixel connected to a data line in the organic luminescent display devices according to the exemplary embodiments;

FIG. 3 is a cross-sectional view taken along the line I-I′ of FIG. 1;

FIG. 4 is a cross-sectional view taken along the line II-II′ of FIG. 1;

FIG. 5 is a cross-sectional view taken along the line III-III′ of FIG. 1;

FIG. 6 is a flowchart illustrating a method of manufacturing an organic luminescent display device according to an exemplary embodiment and

FIG. 7 is a flowchart illustrating a method of manufacturing an organic luminescent display device according to another exemplary embodiment.

### DETAILED DESCRIPTION OF CERTAIN INVENTIVE EMBODIMENTS

Advantages and features and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete. In the drawings, sizes and relative sizes of layers and regions may be exaggerated for clarity.

It will be understood that when an element or layer is referred to as being “on” another element or layer, the element or layer can be directly on another element or layer or intervening elements or layers may also be present. In contrast, when an element is referred to as being “directly on” another element or layer, there are no intervening elements or layers present. As used herein, the term “and/or” includes any and all combinations of one or more of the associated listed items.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures.

Embodiments are described herein with reference to plan and cross-section illustrations that are schematic illustrations of idealized embodiments. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

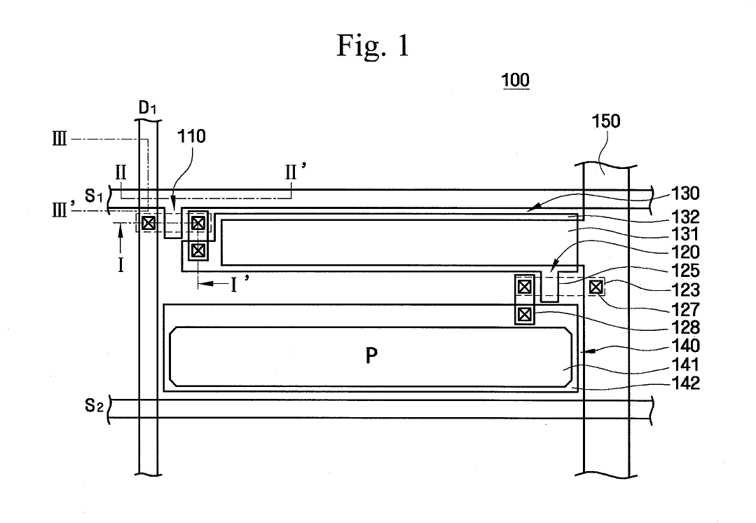

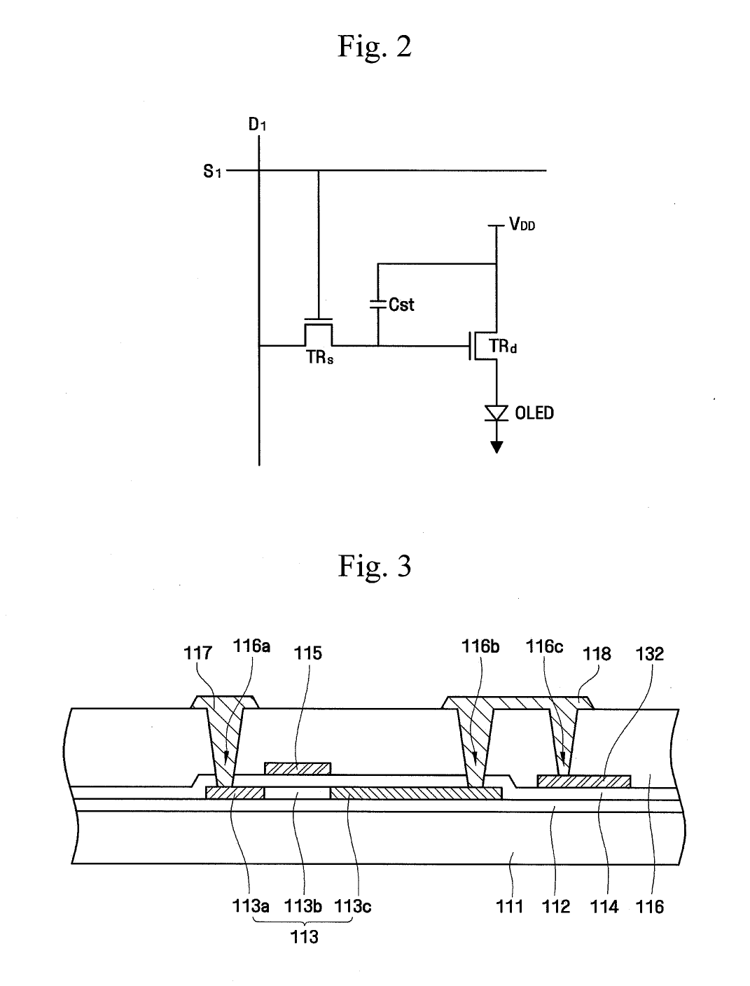

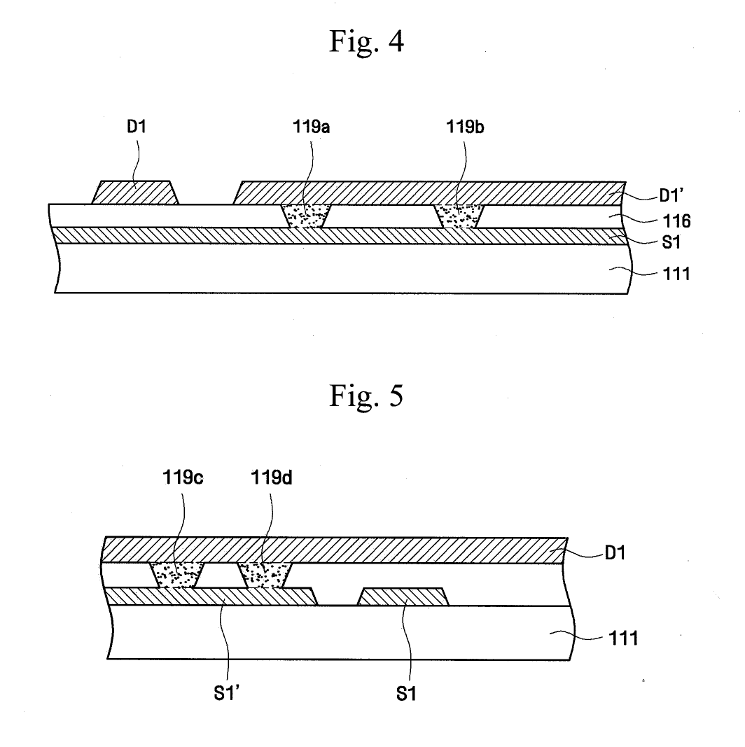

Hereinafter, exemplary embodiments are described in further detail with reference to the accompanying drawings. Organic luminescent display devices according to exemplary embodiments of the present invention are described with reference to FIGS. 1 through 5. FIG. 1 is a plan view of organic luminescent display devices according to certain exemplary embodiments. FIG. 2 is an equivalent circuit diagram of one pixel connected to a data line D1 in the organic luminescent display devices according to the exemplary embodiments. FIG. 3 is a cross-sectional view taken along the line I-I′ of FIG. 1. FIG. 4 is a cross-sectional view taken along the line II-II′ of FIG. 1. FIG. 5 is a cross-sectional view taken along the line of FIG. 1.

Referring to FIGS. 1 and 2, an organic luminescent display device 100 according to an exemplary embodiment includes a scan line S1 and a data line D1 which intersect each other at different levels, an interlayer insulating film 116 which insulates the scan line S1 from the data line D1, a residual data line D1′ which is insulated and formed separately from the data line D1, extends parallel to the scan line Si and is connected to the scan line S1 by a plurality of contact holes, a plurality of pixels P which are formed in a region defined by the scan line S1 and the data line D1, and one or more thin-film transistors (TFTs) 110 and 120 which selectively apply voltages to the pixels P.

In the organic luminescent display device 100 according to the current exemplary embodiment, one pixel region includes a scan line and a data line which intersect each other, and pixels P are formed in the pixel region. The above-mentioned phrase ‘at different levels’ denotes that the scan line and the data line are formed at different positions. That is, the scan line and the data line may have different distances from a substrate. One or more scan lines and a plurality of data lines may be provided in one pixel region according to the number of pixels of the organic luminescent display device 100. In FIG. 1, two scan lines Si and S2 and one data line D1 are provided in one pixel region. However, the present invention is not limited thereto. A plurality of data lines may be provided in one pixel region in order to reduce the resistive-capacitive (RC) delay as described above.

The scan lines S1 and S2 extend in a first direction to deliver scan signals, and the data line D1 extends in a second direction intersecting the first direction, in which the scan lines S1 and S2 extend, and delivers a data signal.

The pixels P of n different colors may be alternately arranged in the first direction or the second direction. Here, each of the pixels P may be connected to any one of n data lines formed successively on a side of the pixels P. Each of the pixels P may be connected to a different data line according to the color thereof. For example, three pixels P displaying red, green and blue may be alternately arranged in the second direction, and three data lines corresponding to the red, green and blue pixels may be successively formed in the second direction on a side of the red, green and blue pixels P. Here, the first direction may be a row direction, and the second direction may be a column direction.

Referring to FIGS. 1 and 2, the organic luminescent display device 100 according to the current exemplary embodiment may include a first thin-film transistor (TFT) 110 or TRs, a second TFT 120 or TRd, a first capacitor 130 or Cst, and an organic light-emitting diode 140 or OLED in one pixel region.

The first TFT 110 or TRs functions as a switching element that selects a pixel to emit light by switching a data voltage applied to the data line D1 in response to a select signal transmitted to the scan line S1. The first TFT 110 or TRs may include a first gate electrode 115, a first source electrode 117, a first drain electrode 118, and a first active layer 113. Certain aspects of specific configurations of the first TFT 110 or TRs are described later with reference to FIG. 3.

The second TFT 120 or TRd functions as a driving transistor that drives the selected organic light-emitting diode 140 or OLED. The second TFT 120 or TRd includes a second gate electrode 125, a second source electrode 127, a second drain electrode 128, and a second active layer 123. The structure of the second TFT 120 or TRd may be identical to that of the first TFT 110 or TRs.

The second gate electrode 125 is connected to a first lower electrode 132 of the first capacitor 130 or Cst, the second source electrode 127 is connected to a common power supply line 150 or VDD by a contact hole, and the second drain electrode 128 is connected to a pixel electrode 142 of the organic light-emitting diode 140 or OLED by a contact hole. In this structure, when the first TFT 110 or TRs is turned on by a select signal, a data voltage is delivered to the second gate electrode 125 of the second transistor 120 or TRd, and a current is supplied to the pixel electrode 142 according to the data voltage.

The first capacitor 130 or Cst includes the first lower electrode 132 and a first upper electrode 131 with the interlayer insulating film 116 interposed therebetween. The first lower electrode 132 is connected to the first drain electrode 118 of the first TFT 110 or TRs by a contact hole 116c, and the first upper electrode 131 is connected to the common power supply line 150 or VDD.

In this structure, a voltage corresponding to a difference between a data voltage delivered from the first TFT 110 or TRs and a common voltage applied from the power supply line 150 or VDD to the second TFT 120 or TRd is stored in the first capacitor 130 or Cst, and a current corresponding to the voltage stored in the first capacitor 130 or Cst flows to the organic light-emitting diode 140 or OLED via the second TFT 120 or TRd. Accordingly, the organic light-emitting diode 140 or OLED emits light based on the data voltage.

The organic light-emitting diode 140 or OLED includes a pixel electrode (not shown) which corresponds to an anode (i.e., a hole injection electrode), the pixel electrode 142 which corresponds to a cathode (i.e., an electron injection electrode), and an organic light-emitting layer 141 disposed between the anode and the cathode. Holes and electrons are injected from the anode and the cathode into the organic light-emitting layer 141, and the injected holes and electrons combine to form excitons. The excitons emit light when they return from an excited state to their ground state. The pixel electrode 142 may be made of a transparent conductive material such as indium tin oxide (ITO), indium zinc oxide (IZO), ZnO, or In2O3.

Referring to FIG. 3, the first TFT 110 includes a buffer layer 112 formed on a substrate 111. The substrate 111 may be made of an insulating material such as glass, quartz, ceramic or plastic, or metal. The buffer layer 112 prevents penetration of impurities into the substrate 111 and planarizes the surface of the substrate 111. As long as the buffer layer 112 can perform these functions, it can be made of any material. The buffer 112 is not essential and can be omitted depending on the type of the substrate 110 and processing conditions.

The first active layer 113 is formed on the buffer layer 112. The first active layer 113 may be made of amorphous silicon or polycrystalline silicon. When made of polycrystalline silicon, the first active layer 113 can have higher charge mobility than when made of amorphous silicon. The first active layer 113 includes a first channel region 113b which may be undoped with impurities and a first source region 113a and a first drain region 113c which are situated on both sides of the first channel region 113b and may be doped with p-or n-type impurities. The type of impurities may vary according to the type of the first TFT 110.

A gate insulating film 114 is formed on the first active layer 113. The gate insulating film 114 may be made of silicon nitride or silicon oxide. The first gate electrode 115 is formed on the gate insulating film 114 and overlaps the first channel region 113b. The first gate electrode 115 is electrically connected to the scan line S1.

The interlayer insulating film 116 covering the first gate electrode 115 is formed on the gate insulating film 114. The interlayer insulating film 116 insulates not only the first gate electrode 115 from the first source electrode 117 but also the scan line S1 from the data line D1 in a region other than the first TFT 110, as will be described later. In addition, as will be described later, a plurality of contact holes are formed in part of the interlayer insulating film 116 to connect a residual scan line S1′ to the data line D1 or connect the residual data line D1′ to the scan lien S1.

The first source electrode 117 and the first drain electrode 118 are formed on the interlayer insulating film 116 and are electrically connected to the first source region 113a and the first drain region 113c of the first active layer 113 by contact holes 116a and 116b formed in the interlayer insulating film 116, respectively.

The first source electrode 117 may be electrically connected to the data line D1. In FIG. 3, the data line D1 is electrically connected to the first source region 113a of the first active layer 113 by the contact hole 116a. That is, the data line D1 becomes a part of the first source electrode 117 in FIG. 3. The first drain electrode 118 is electrically connected to the first lower electrode 132 of the first capacitor 130 by the contact hole 116c. In this structure, a corresponding pixel P may be electrically connected to the data line D1 on a side of the pixel P by the first TFT 110. In addition, the first TFT 110 is driven by a gate voltage applied to the scan line S1 and delivers a data voltage applied to the data line D1 to the second TFT 120.

FIG. 4 is a cross-sectional view taken along the line II-II′ of FIG. 1. In FIG. 4, the positional relationship between the data line D1, the residual data line D1′, and the scan line S1 is illustrated.

All or part of wiring lines according to the current exemplary embodiment, that is, a data line and a scan line, may form a double wiring structure. In the current exemplary embodiment, the residual data line D1′ is provided. The residual data line D1′ is made of the same material as the data line D1 and is insulated and formed separately from the data line D1. In addition, the residual data line D1′ extends parallel to the scan line S1 and is connected to the scan line S1 by a plurality of contact holes 119a and 119b. Therefore, a gate voltage applied to the scan line S1 is delivered to the first TFT 110 via the scan line S1 and the residual data line D1′.

In FIG. 1, the scan line S1 appears to be a single wiring structure. However, this is because the residual data line D1′ is above the scan line S1 and parallel to the scan line S1. In the current exemplary embodiment, the scan line S1 and the residual data line D1′ extending parallel to each other form a double wiring structure.

The double wiring structure composed of upper and lower wiring lines can significantly reduce resistance compared with a conventional single wiring structure. That is, since the scan line S1 and the residual data line D1′, which are resistors, are connected in parallel to each other, their total composite resistance is significantly lower than the resistance of the single scan line S1, as given by Equation 1 below.

1/R=1/R1+1/R2 (1)

For example, when the resistance of the scan line S1 is 0.2 Ω and that of the residual data line D1′ is 0.07 Ω, the total composite resistance is 0.05 Ω. That is, the composite resistance of the scan line S1 and the residual data line D1′ connected in parallel amounts to a quarter of the resistance of the single scan line S1. The composite resistance of the scan line S1 and the residual data line D1′ connected in parallel may vary according to unique resistance values of the scan line S1 and the residual data line D1′. However, the composite resistance of the scan line S1 and the residual data line D1′ connected in parallel is significantly lower than the resistance of the single scan line S1.

The residual data line D1′ may be made of the same material as the data line D1. The residual data line D1′ may be made of a Mo—Al—Mo alloy or a Mo—Al alloy in view of the composite resistance. The material for the scan line S1 may also be selected in view of resistance. For example, when the interlayer insulating film 116 is formed to a thickness of 3,000 Å or more, the scan line S1 under the interlayer insulating film 116 may be made of the same material as that of the residual data line D1′, such as a Mo—Al—Mo alloy or a Mo—Al alloy, in order to minimize contact resistance. On the other hand, when the interlayer insulating film 116 is formed to a thickness of less than 3,000 Å, the total resistance may not greatly be affected by contact resistance. However, hillocks of Al may be formed, thus deteriorating reliability. To prevent the formation of Al hillocks, the scan line S1 may be made of Mo or a Mo—W alloy excluding Al, unlike the residual data line D1′.

In the organic luminescent display device 100 according to the current exemplary embodiment, since the scan line S1 and the residual data line D1′ are connected in parallel, resistance can be significantly reduced, and the problem of RC delay can be solved or greatly reduced. In the current exemplary embodiment, a case where one residual data line D1′ formed by one data line D1 and one scan line S1 form parallel resistance has been described. However, the present invention is not limited to this case. Different residual data lines D1′, D2′, D3′ . . . and different scan lines S1, S2, S3 . . . can also form parallel resistance in each pixel region. In addition, a case where two contact holes 119a and 119b are provided has been described. However, the present invention is not limited to this case, and additional contact holes may further be formed.

FIG. 5 is a cross-sectional view taken along the line of FIG. 1. In FIG. 5, the positional relationship between a data line D1, a scan line S1, and a residual scan line S1′ according to another exemplary embodiment of the present invention is illustrated.

An organic luminescent display device according to the current exemplary embodiment includes the scan line S1 and the data line D1 which intersect each other at different levels, an interlayer insulating film 116 which insulates the scan line S1 from the data line D1, the residual scan line S1′ which is insulated and formed to be spaced apart from the scan line S1, extends parallel to the data line D1 and is connected to the data line D1 by a plurality of contact holes, a plurality of pixels P which are formed in a region defined by the scan line S1 and the data line D1, and one or more TFTs 110 and 120 which selectively apply voltages to the pixels P.

The configuration of the current exemplary embodiment is substantially the same as that of the previous exemplary embodiment, except that the residual scan line S1′ and the data line D1, instead of the scan line S1 and the residual data line D1′, form a double wiring structure to create parallel resistance. That is, in the current exemplary embodiment, the residual scan line S1′ is provided. The residual scan line S1′ is made of the same material as the scan line S1 and is insulated and formed to be spaced apart from the scan line S1. In addition, the residual scan line S1′ extends parallel to the data line D1 and is connected to the data line D1 by a plurality of contact holes 119c and 119d. Therefore, a driving voltage applied to the data line D1 is delivered to the first TFT 110 via the data line D1 and the residual scan line S1′.

In FIG. 1, the data line D1 appears to be a single wiring structure. However, this is because the residual scan line S1′ is under the data line D1 and parallel to the data line D1. In the current exemplary embodiment, the data line D1 and the residual scan line S1′ extending parallel to each other form a double wiring structure.

The double wiring structure composed of upper and lower wiring lines can significantly reduce resistance compared with a conventional single wiring structure. That is, the data line D1 and the residual scan line S1′, which are resistors, are connected in parallel to form composite resistance, and the composite resistance can be calculated using Equation 1 described above. Since the principle of parallel resistance has been described above, repetitive description thereof is omitted.

As described above, the data line D1 according to the current exemplary embodiment may be made of a Mo—Al—Mo alloy or a Mo—Al alloy.

The residual scan line S1′ may be made of the same material as the scan line S1. The material for the residual scan line S1′ may be selected in view of resistance. For example, when the interlayer insulating film 116 is formed to a thickness of 3,000 Å or more, the residual scan line S1′ under the interlayer insulating film 116 may be made of the same material as that of the data line D1, such as a Mo—Al—Mo alloy or a Mo—Al alloy, in order to minimize contact resistance. On the other hand, when the interlayer insulating film 116 is formed to a thickness of less than 3,000 Å, the total resistance is not greatly affected by the contact resistance. However, hillocks of Al may be formed, thus deteriorating reliability. To prevent the formation of Al hillocks, the residual scan line S1′ may be made of Mo or a Mo—W alloy excluding Al, unlike the data line D1.

In the organic luminescent display device according to the current exemplary embodiment, since the data line D1 and the residual scan line S1′ are connected in parallel, resistance can be significantly reduced, and the problem of RC delay can be solved or greatly reduced. In the current exemplary embodiment, a case where one residual scan line S1′ formed by one scan line S1 and one data line D1 form parallel resistance has been described. However, the present invention is not limited to this case. Different residual scan lines S1′, S2′, S3′ . . . and different data lines D1, D2, D3 . . . can also form parallel resistance in each pixel region. In addition, a case where two contact holes 119c and 119d are provided has been described. However, the present invention is not limited to this case, and additional contact holes may further be formed.

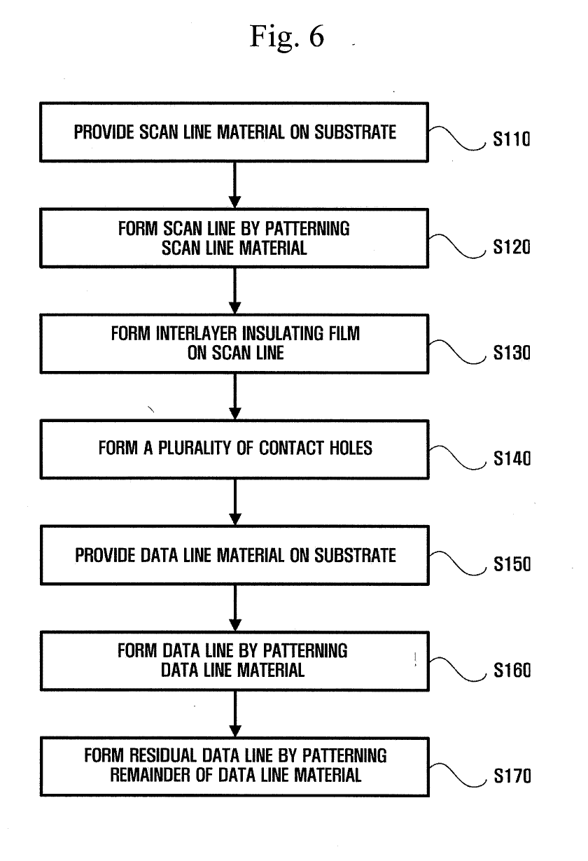

Hereinafter, a method of manufacturing an organic luminescent display device according to an exemplary embodiment of the present invention will be described with reference to FIG. 6. FIG. 6 is a flowchart illustrating a method of manufacturing an organic luminescent display device according to an exemplary embodiment of the present invention.

The method of manufacturing an organic luminescent display device according to the current exemplary embodiment includes providing a scan line material on a substrate (operation S110), forming a scan line by patterning the scan line material (operation S120), forming an interlayer insulating film on the scan line (operation S130), forming a plurality of contact holes in the interlayer insulating film (operation S140), providing a data line material on the substrate (operation S150), forming a data line which extends in a predetermined direction by patterning the data line material (operation S160), and forming a residual data line which extends in a different direction from the predetermined direction and is insulated from the data line by patterning the remainder of the data line material (operation S170). The residual data line and the scan line are connected to each other by the contact holes.

Specifically, a scan line material is provided on a substrate 111 (operation S110). As described above, the scan line material for forming a scan line S1 may be selected in view of the thickness of an interlayer insulating film 116 disposed on the scan line S1. That is, when the interlayer insulating film 116 is to be formed to a thickness of 3,000 Å or more in the forming of the interlayer insulating film (operation S140), the scan line S1 may be made of the same material as a residual data line D1′, which will be described later, that is, may be made of a Mo—Al—Mo alloy or a Mo—Al alloy. Therefore, the scan line material provided on the substrate 111 may be a Mo—Al—Mo alloy or a Mo—Al alloy. A metal or alloy can be provided on the substrate 111 using various conventional deposition methods such as sputtering and spin coating.

The scan line S1 is formed by patterning the scan line material (operation S120). A different etching method, such as dry etching or wet etching, may be used according to the type of the scan line material. Alternatively, a patterning method using a laser may be used. As described above, the scan line S1 may be formed linearly to extend in a first direction of the substrate 111.

The interlayer insulating film 116 is formed on the scan line S1 (operation 130). The interlayer insulating film 116 may insulate a gate electrode from a source/drain electrode in each transistor region 110 or 120. In addition, the interlayer insulating film 116 insulates the scan line S1 from the data line D1 in a wiring region in which the scan line S1 and the data line D1 are formed. There are no restrictions on the material used to form the interlayer insulating film 116. For example, silicon nitride or silicon oxide can be used.

A plurality of contact holes are formed in the interlayer insulating film 116 (operation S140). As described above, the interlayer insulating film 116 is provided on the entire region of the substrate 111 having the gate electrode and the scan line S1 to insulate the source/drain electrode from the data line D1 and the gate electrode from the scan line S1.

In the current exemplary embodiment, since the residual data line D1′ and the scan line S1 are connected to each other by the contact holes such that they form a double wiring structure to create parallel resistance as will be described later, the contact holes are formed in the interlayer insulating film 116.

A data line material is provided on the substrate 111 (operation S150). As described above, the data line material may be a Mo—Al—Mo alloy or a Mo—Al alloy. The data line material may be provided on the substrate 111 using various deposition or coating methods, as described above.

The data line material is patterned to form the data line D1 which extends in a first direction (operation S160). When the scan line S1 is formed in the first direction, the data line D1 may be formed in a second direction perpendicular to the first direction. The scan line S1 and the data line D1 intersect each other in a pixel region.

The remainder of the data line material is patterned to form the residual data line D1′ which extends in a direction different from the first direction and which is insulated from the data line D1 (operation S170). As described above with reference to FIG. 4, part of the data line material may be patterned to form the data line D1 extending in the second direction, and the remainder of the data line material may be patterned to form the residual data line D1′ extending in a direction different from the second direction, for example, in the first direction parallel to the scan line S1. Therefore, the data line D1 and the residual data line D1′ may be made of the same material, and the residual data line D1′ may be formed above the scan line S1 to be parallel to the scan line S1.

Here, the data line material fills the contact holes formed in the interlayer insulating film 116 in the forming of the contact holes (operation S140). Therefore, the residual data line D1′ and the scan line S1 may be electrically connected to each other by the contact holes. That is, the contact holes may penetrate from a top surface of the scan line S1 to a bottom surface of the residual data line D1′.

Since the residual data line D1′ and the scan line S1 are connected to each other, if the residual data line D1′ is electrically connected to or in contact with the data line D1, the data line D1 and the scan line S1 may be connected to each other, thus producing a defective pixel. Therefore, as described above, the residual data line D1′ must be insulated and formed spaced apart from the data line D1. In this case, the residual data line D1′ may be formed above the scan line S1 to extend parallel to the scan line S1 but may not be formed in parts of a region in which the data line D1 intersects the scan line S1.

When the scan line S1 and the residual data line D1′ are arranged to form a double wiring structure as described above, they create parallel resistance, thus lowering a value of total composite resistance for a voltage applied along the first direction of the scan line S1.

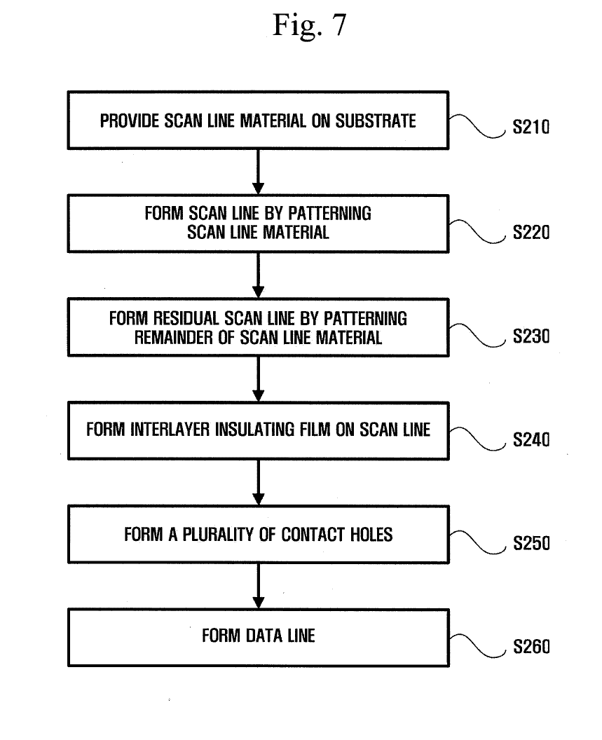

Hereinafter, a method of manufacturing an organic luminescent display device according to another exemplary embodiment is described with reference to FIG. 7. FIG. 7 is a flowchart illustrating a method of manufacturing an organic luminescent display device according to another exemplary embodiment.

The method of manufacturing an organic luminescent display device according to the current exemplary embodiment includes providing a scan line material on a substrate (operation S210), forming a scan line which extends in a predetermined direction by patterning the scan line material (operation S220), forming a residual scan line which extends in a direction different from the predetermined direction and is insulated from the scan line by patterning the remainder of the scan line material (operation S230), forming an interlayer insulating film on the scan line (operation S240), forming a plurality of contact holes at locations, which correspond to the residual scan line, in the interlayer insulating film (operation S250), providing a data line material on the substrate, and forming a data line by patterning the data line material (operation S260).

The other processes of the manufacturing method are similar to those of the manufacturing method according to the previous exemplary embodiment, except that the residual scan line, which forms a double wiring structure with the data line, is formed by patterning the remainder of the scan line material, instead of forming a residual data line, which forms a double wiring structure with the scan line, by patterning the remainder of the data line material.

When the data line D1 and the residual scan line S1′ are arranged to form a double wiring structure as described above, they create parallel resistance, thus lowering a value of total composite resistance for a voltage applied along a second direction of the data line D1 and reducing the RC delay. In addition, since resistance can be reduced without increasing the thickness of each of the scan line S1 and the data line D1, the total thickness can be maintained small.

While various aspects and features have been particularly shown and described with reference to exemplary embodiments, it will be understood by those of ordinary skill in the art that various changes in form and detail may be made therein without departing from the spirit and scope of the present invention. The exemplary embodiments should be considered in a descriptive sense only and not for purposes of limitation.

What is claimed is:

1. An organic luminescent display device comprising:
a scan line and a data line which intersect each other at different levels;
an interlayer insulating film which insulates the scan line from the data line;
a residual data line which is insulated and formed spaced apart from the data line, wherein the residual data line is parallel to the scan line and is connected to the scan line by a plurality of contact holes;
a plurality of pixels formed in a region defined by the scan line and the data line; and
one or more thin-film transistors which selectively apply voltages to the pixels.

2. The display device of claim 1, wherein the data line is made of a molybdenum-aluminum-molybdenum alloy or a molybdenum-aluminum alloy.

3. The display device of claim 1, wherein the interlayer insulating film has a thickness of less than 3,000 Å.

4. The display device of claim 3, wherein the scan line is made of molybdenum or a molybdenum-tungsten alloy.

5. The display device of claim 1, wherein the interlayer insulating film has a thickness of 3,000 Å or more.

6. The display device of claim 5, wherein the scan line is made of a molybdenum-aluminum-molybdenum alloy or a molybdenum-aluminum alloy.

7. The display device of claim 1, wherein the residual data line is made of the same material as the data line.

8. An organic luminescent display device comprising:
a scan line and a data line which intersect each other at different levels;
an interlayer insulating film which insulates the scan line from the data line;
a residual scan line which is insulated and formed spaced apart from the scan line, wherein the residual scan line is parallel to the data line and is connected to the data line by a plurality of contact holes;
a plurality of pixels formed in a region defined by the scan line and the data line; and
one or more thin-film transistors which selectively apply voltages to the pixels.

9. The display device of claim 8, wherein the data line is made of a molybdenum-aluminum-molybdenum alloy or a molybdenum-aluminum alloy.

10. The display device of claim 8, wherein the interlayer insulating film has a thickness of less than 3,000 Å.

11. The display device of claim 10, wherein the scan line is made of molybdenum or a molybdenum-tungsten alloy.

12. The display device of claim 8, wherein the interlayer insulating film has a thickness of 3,000 Å or more.

13. The display device of claim 12, wherein the scan line is made of a molybdenum-aluminum-molybdenum alloy or a molybdenum-aluminum alloy.

14. The display device of claim 8, wherein the residual scan line is made of the same material as the scan line.

15. A method of manufacturing an organic luminescent display device, the method comprising:
providing a scan line material on a substrate;
forming a scan line by patterning the scan line material;
forming an interlayer insulating film on the scan line;
forming a plurality of contact holes in the interlayer insulating film;
providing a data line material on the substrate;
forming a data line which extends in a first direction by patterning the data line material; and
forming a residual data line which extends in a direction different from the first direction and is insulated from the data line by patterning the remainder of the data line material,
wherein the residual data line and the scan line are connected to each other by the contact holes.

16. The method of claim 15, wherein the data line is made of a molybdenum-aluminum-molybdenum alloy or a molybdenum-aluminum alloy.

17. The method of claim 15, wherein the interlayer insulating film has a thickness of less than 3,000 Å.

18. The method of claim 17, wherein the scan line is made of molybdenum or a molybdenum-tungsten alloy.

19. The method of claim 15, wherein the interlayer insulating film has a thickness of 3,000 Å or more.

20. The method of claim 19, wherein the scan line is made of a molybdenum-aluminum-molybdenum alloy or a molybdenum-aluminum alloy.

21. The method of claim 15, wherein the residual data line is made of the same material as the data line.

22. A method of manufacturing an organic luminescent display device, the method comprising:
providing a scan line material on a substrate;
forming a scan line which extends in a first direction by patterning the scan line material;
forming a residual scan line which extends in a direction different from the first direction and is insulated from the scan line by patterning the remainder of the scan line material;
forming an interlayer insulating film on the scan line;
forming a plurality of contact holes at locations, which correspond to the residual scan line, in the interlayer insulating film;
providing a data line material on the substrate; and
forming a data line by patterning the data line material.

23. The method of claim 22, wherein the data line is made of a molybdenum-aluminum-molybdenum alloy or a molybdenum-aluminum alloy.

24. The method of claim 22, wherein the interlayer insulating film has a thickness of less than 3,000 Å.

25. The method of claim 24, wherein the scan line is made of molybdenum or a molybdenum-tungsten alloy.

26. The method of claim 22, wherein the interlayer insulating film has a thickness of 3,000 Å or more.

27. The method of claim 26, wherein the scan line is made of a molybdenum-aluminum-molybdenum alloy or a molybdenum-aluminum alloy.

28. The method of claim 22, wherein the residual scan line is made of the same material as the scan line.
